(19) United States
(12) Patent Application Publication
(10) Pub. No.: US 2003/0176307 A1
(43) Pub. Date: Sep. 18, 2003

(54) Enzyme containing tablets

(76) Inventors: Chris Efstathios Housmekerides, Ludwigshafen (DE); Danilo Bortholato, Mira (IT); Luca Spadoni, Mirano (IT)

Correspondence Address: Norris McLaughlin & Marcus, 30th Floor, 220 East 42nd Street, New York, NY, 10017, US

(21) Appl. No.: 10/380,586

(22) PCT Filed: Sep. 18, 2001
(86) PCT No.: PCT/GB01/04155

(30) Foreign Application Priority Data
Sep. 20, 2000 (GB) 0023053.2
Apr. 4, 2001 (GB) 0108407.8
May 18, 2001 (GB) 0112173.0

(51) Int. Cl. C11D 3/00

(52) U.S. Cl. 510/392; 510/447

(57) ABSTRACT

This invention relates to solid laundry additive compositions in tablet form. More particularly, it relates to enzyme-containing bleaching compositions for use primarily in home laundering.

This invention relates to solid laundry additive compositions in tablet form. More particularly, it relates to enzyme-containing bleaching compositions for use primarily in home laundering.

It has long been known that peroxygen bleaches are effective for stain and/or soil removal from clothing and other fabric materials. Sodium perborate, sodium percarbonate and sodium persulfate have been the peroxygen compounds of choice but, in order to be effective, these compounds had to be employed at a wash cycle temperature of 60° C. or higher. As long as the wash temperature in a home washing machine is set to a “hot” setting (assuming that such hot water tank temperature is available), these peroxygen bleaches performed very well. However, for many articles of clothing and/or for economic reasons, many users preferred—or were required—to use a “warm” or “cold” temperature setting in home laundering machines. At such lower temperatures, these peroxygen bleaches lost most of their effectiveness. In order to restore the effectiveness of peroxygen bleaches, formulations were developed which combines the peroxygen compounds with other substances, generally referred to as bleach activators, but sometimes referred to as bleach precursors, which render these peroxygen bleaches effective at temperatures below 60° C. Numerous compounds have been disclosed in the art as bleach activators, including various N-acetylated amines, in particular tetraacetylethylenediamine (TAED).

Suitable bleach activity results from the reaction of the peroxygen bleach with the bleach activator in the washing liquor. However, in a washing powder composition or in a laundry additive composition intended to be used as an adjunct to a washing powder, there is frequently residual moisture present. In the presence of moisture, if the peroxygen bleach and the bleach activator are unprotected, there will be a premature reaction which would render the peroxygen bleach ineffective. In order to solve this problem, the peroxygen bleach particles and/or the activator particles were coated and/or admixed with various other substances, which would prevent such premature reaction. Since the bleach-containing composition was intended for use in laundry wash water, all of the coating substances and other stabilizing agents have to be water soluble although, of course, they can be selected with regard to relative solubility rates, etc.

Of the various known peroxygen bleaching compounds, sodium percarbonate has certain well recognized advantages over other compounds, such as sodium borate in that it is a more effective bleach in so-called cold water washing, i.e., temperatures of about 20° C. since, at that temperature, sodium percarbonate dissolves more rapidly. A problem with sodium percarbonate, however, is that at higher temperatures—for example, 35° C. or higher, which are often encountered in storage and shipping—sodium percarbonate is less stable. In order to prevent degradation of the percarbonate, the already coated percarbonate particles are admixed with other ingredients which have a stabilizing effect. By providing a two-phase composition in which the first phase comprises the peroxygen bleach and various stabilizing agents, and the second phase comprises the bleach activator and various stabilizing agents, the percarbonate can be stabilized against degradation and against premature reaction with the bleach activator. Each phase is separately prepared and, after preparation, can be mixed together, tabletted and, if desired, coated with a suitable water soluble coating material. Preferably, the two phases remain segregated and are combined into a single compressed tablet in, for example, a two-layered structure or a structure in which the smaller volume phase is encapsulated or embedded either wholly or partly by the larger volume phase.

Thus, there have been a number of reasonably successful solutions to the stability problems involving peroxygen bleach compounds, but most of the properly stabilized compositions do not contain enzymes. As is well known in the art, enzymes are a desirable component of laundry detergents and detergent additive products. It has long been recognized that, when enzymes are incorporated into such products, enzyme stabilizers must be employed. However, such enzyme stabilizers often will decrease the stability of the peroxygen bleach compounds. In laundry additive tablets containing both enzymes and peroxygen bleaches, the problem has been somewhat alleviated by providing a segregated two-phase tablet in which the enzymes is incorporated into the phase containing the bleach activator. This has proven to be a generally satisfactory solution provided, of course, that there is an adequate stabilization system in both phases. Nevertheless, improvements in such enzyme-containing bleaching tablets are desirable. It would be useful to develop enzyme-containing peroxygen bleach tablets with high enzyme concentrations. Previously it was believed that increasing the enzyme concentration above 5.5% wt in the tablet or region of the tablet would lead to an increase in the instability of the enzyme. Proteases may self degrade under high concentration. In any event a higher stability would not be expected.

Surprisingly we have found that higher concentrations of enzyme can indeed be added to tablets, above 5.5% wt, without negatively affecting the stability of the enzyme, even in the presence of a peracid, such as a percarbonate. In fact we have found several advantages including, decrease in the disintegration time, increase in the speed of production because compression is easier and faster, and an increase in the stability of the enzyme by the addition of such high levels of enzyme.

In addition it has now been surprisingly found that, in a segregated two-phase enzyme-containing peroxygen bleach tablet, by adding relatively large amounts of a hydroxydi- or hydroxytri-carboxylic acid, preferably in the form of an alkali metal salt, and of an alkali metal bicarbonate, one can obtain a tablet with excellent bleach stability and excellent enzyme stability. Preferably, the key ingredients are sodium citrate and sodium bicarbonate, both of which are readily available, inexpensive and environmentally acceptable.

This invention provides a high enzyme-containing two-phase bleaching tablet in which a first phase is an admixture comprising

a peroxygen bleach compound,

an aliphatic hydroxydi- or hydroxytri-carboxylic acid or an alkali metal salt thereof,

optionally, a finely divided water-soluble cellulose,

optionally, polyethylene glycol having a molecular weight of from about 600 (ideally 1500) to about 10,000,

a carbonate salt selected from the group consisting of alkali metal carbonates, bicarbonates and sesquicarbonates, and optionally, a disintegrant,

and a second phase is an admixture comprising

at least 5.5% wt preferably greater than 10% wt, greater than 15% wt, greater than 20% wt, greater than 25% wt, greater than 30% wt, or greater than 35% wt, of an enzyme,

an aliphatic hydroxydi- or hydroxytri-carboxylic acid or an alkali salt thereof, optionally, a finely divided water-soluble cellulose,

optionally, polyethylene glycol having a molecular weight of from about 600 (ideally 1500) to about 10,000,

a carbonate salt selected from the group consisting of alkali metal carbonates, bicarbonates and sesquicarbonates, and optionally, a disintegrant.

Optionally a bleach activator can be added to the enzyme phase of any tablet at up to 50% wt. Preferably the tablets do not have the presence of a bleach activator. Performance is maintained in low temperatures washed even in the absence of bleach activators, compared with tablets which do contain bleach activators. A preferred bleach activator are the N-acetylated amines, in particular tetraacetylethylenediamine (TAED). Preferred levels are 10-70% wt, preferably 30-60% wt, in the enzyme phase.

More particularly, this invention provides an enzyme-containing two-phase bleaching tablet in which a first phase is an admixture comprising

a peroxygen bleach compound,

an aliphatic hydroxydi- or hydroxytri-carboxylic acid or an alkali metal salt thereof,

a finely divided water-soluble cellulose,

polyethylene glycol having a molecular weight of from about 600 (ideally 1500) to about 10,000,

a carbonate salt selected from the group consisting of alkali metal carbonates, bicarbonates and sesquicarbonates, and

polyvinylpolypyrrolidone,

and a second phase is an admixture comprising

an enzyme,

an aliphatic hydroxydi- or hydroxytri-carboxylic acid or an alkali salt thereof,

a finely divided water-soluble cellulose,

polyethylene glycol having a molecular weight of from about 600 (ideally 1500) to about 10,000,

a carbonate salt selected from the group consisting of alkali metal carbonates, bicarbonates and sesquicarbonates, and

polyvinylpyrrolidone

wherein the tablet comprises from about 50% to about 95% by weight of the first phase admixture and from 50% to about 5% by weight of the second phase admixture. The preferred peroxygen bleach compound is sodium percarbonate.

The preferred hydroxycarboxylic acid is citric acid and the preferred salt thereof is sodium citrate. The preferred cellulose is microcrystalline cellulose. The preferred molecular weight range of the polyethylene glycol is from about 5,000 to about 7,000. The preferred carbonate salt is sodium bicarbonate.

Any hydrolytic enzyme commonly employed in laundry care formulations is suitable for use in these compositions, but preferred are enzyme components containing protease and more than 10μ amylase.

The invention also covers the use of the aforementioned tablets in connection with the laundering of clothing and other fabrics.

The peroxygen bleach compound is any compound capable of releasing hydrogen peroxide in aqueous solution. Hydrogen peroxide sources are well known in the art. They include alkali metal peroxides and organic peroxide salts such as alkali metal perborates, percarbonates, perphosphates and persulfates. Mixtures of two or more such compounds may be suitable. For purposes of this invention, the preferred persalt for use is sodium percarbonate, although sodium perborate tetrahydrate is also within the scope of the invention.

Sodium percarbonate, Na₂CO₃.1.5H₂O₂, is a perhydrate rather than a true persalt, and it can release its hydrogen peroxide on crystallization without requiring dissolution. One of the advantages of using sodium percarbonate is that it dissolves more slowly than sodium perborate in water so that the granule structure is maintained in the wash liquor for a sufficient length of time for the bleaching effect to be operable. The peroxygen bleach compound is present only in the first phase admixture and comprises from about 60% to about 90%, preferably from 70% to 80% by weight, of said first admixture.

The enzyme present in the inventive composition include the various proteases, cellulases, lipases, amylases and mixtures thereof, which are designed to remove a variety of soils and stains from fabrics. Preferably, the enzymes are a mixture of proteases and amylases, although the enzyme component can consist of proteases only.

The protease added can be of vegetable, animal or microbial origin. Preferably, it is of the latter origin, which includes yeasts, fungi, molds and bacteria. Particularly preferred are bacterial subtilis in type proteases, obtained from e.g., particular strains of B. subtilis and B. licheniformis. Examples of suitable commercially available proteases are Alcalase, Savinase, Esperase, all of NOVO Industry A/S; Maxatase and Maxacal of Gist-Brocades; Kazusase of Showa Denko; BPN and BPN′ proteases and so on. An example of an enzyme component having both protease and amylase is Purafect OX Blend 45, available from Genencor.

The enzyme component, which is present only in the second phase admixture comprises from about 15% to 30%, preferably from 20% to 25% by weight, of said admixture. In high enzyme concentration tablets the enzyme content is at least 5.5% wt preferably greater than 10% wt, greater than 15% wt, greater than 20% wt, greater than 25% wt, greater than 30% wt, or greater than 35% wt.

It will be appreciated by the skilled person that the levels of enzyme quoted are the levels of raw material added to the admixture. Enzymes sold for use in detergency are not provided in pure form but are provided as mixtures enzyme plus other excipients necessary to stabilise the enzyme. Typically such preparations only contain less than 10% wt of enzyme, normally less than 5% wt of enzyme. Typically the enzyme is supplied as a granulate.

The first phase and second phase admixture preferably contains an aliphatic hydroxydi- or hydroxytri-carboxylic acid or an alkali metal salt thereof, preferably citric acid or sodium citrate. The hydroxycarboxylic acid component is present in an amount of from about 3% to about 8%, preferably from 4% to 6.5%, by weight of the first phase admixture.

From a standpoint of effectiveness and availability, the most suitable salt for the second phase is sodium citrate, which is conveniently available in the form of its dihydrate. The hydroxycarboxylic acid salt is present in the second phase in substantial amounts ranging from about 20% to about 40%, preferably from 25% to 35%, by weight of said second phase.

A finely divided water-soluble cellulose, whose purpose is initially to act as a coating material for the percarbonate and the enzyme, is present in both phases. Examples of such celluloses are methyl cellulose, ethyl cellulose, hydroxyethyl cellulose, methylhydroxyethyl cellulose, methylhydroxypropyl cellulose, sodium carboxymethyl celluloses and sodium methylcarboxymethyl cellulose. The cellulose should be in microcrystalline in form and is present in each of the two phases in amounts ranging from about 4% to about 10%, preferably from 6% to 8%, by weight, of each admixture. A suitable cellulose is the product sold under the trademark AVICEL of FMC Corporation.

A polyethylene glycol of molecular weight ranging from about 600 to 10,000, is preferably present as an ingredient in both phases of the admixture. In the tablet composition of the invention, its initial purpose is to act as a binding agent; subsequently, in the wash liquor, the polyethylene glycol will serve, inter alia, as an agent to hinder the re-deposition of soil. The polyethylene glycol used in each phase, which conveniently can be the same substance, preferably has a molecular weight of from between 5,000 and about 7,000 and is present in each phase in amounts ranging from about 2% to about 7%, preferably from 3% to 5%, by weight, of said phase.

The carbonate salt, which is a required ingredient in the second phase and it is preferably also present in the first phase, is an alkali metal carbonate, bicarbonate or sesquicarbonate, preferably a bicarbonate and most preferably sodium bicarbonate. The carbonate salt is present in the first phase in amounts ranging from about 1% to about 4%, preferably from 1.5% to 5% ideally 1.5% to 3.5%, by weight of said first phase. The carbonate salt is present in the second phase in larger amounts, ranging from about 20% to about 40%, preferably from 25% to 35%, by weight of said second phase.

In order to control the dissolution process of the tablet and to assure that each of the two phases disintegrates at approximately the same time and at the same rate, a disintegrant should be included in each phase. A suitable disintegrant is polyvinylpolypyrrolidone (PVP). The PVP should be present in each phase in amounts ranging from about 0.5% to about 3.0%, preferably from 1% to 2%, by weight, of each phase. A suitable disintegrant is the product sold under the trademark Gafdis by ISP Investments.

Each phase admixture also preferably contains a crystalline layered sodium silicate of the types generally described in U.S. Pat. Nos. 4,664,839 and 5,891,837. This ingredient is present in each phase in an amount of from about 2% to about 7%, preferably from 3% to 5%, by weight.

In addition to the foregoing ingredients, each phase admixture can include additional ingredients commonly used in products of this type, for example, perfumes and dyes. It is recommended that, particularly where the two phases are segregated, a dye be added to at least one of the two phases. Perfumes and dyes, if present, should be added in amounts ranging from about 0.01% to about 0.1%.

In the tablet compositions of this invention, the relative amounts of each phase should be adjusted so that effective amounts of the peroxygen bleach and the enzyme are provided to the aqueous wash liquor. Using the above-described admixtures for the two phases, the ratio of the first phase to the second phase in the final tablet composition can range from about 50% to 90% of the first phase, and from about 50% to about 5%, by weight, of the second phase. Preferably, the phase ratios are from about 60% to about 85% by weight of the first phase and about 40% to about 15% by weight of the second phase. More preferably, the phase ratios are from 70% to 80% of the first phase and from 30% to 20% of the second phase, by weight.

It is essential that the peroxygen bleach on the one hand and the enzyme and the alkali metal hydroxycarboxylic salt on the other be separated in the final tablet composition. Although such separation can be attained as a result of some of the other ingredients in each phase acting as coating materials for the peroxygen bleach and the enzyme, a more effective way of attaining the required separation is to formulate the tablet so that each phase occupies a discrete region within the tablet; i.e., the tablet should be formulated so that the peroxygen-containing phase and the enzyme-containing phase are completely segregated. The most convenient way to do this is to provide a tablet consisting of separate layers of the first phase and the second phase. However, other methods of segregation, such as, for example, the second phase being embedded in or surrounded by the first phase, etc., may also be employed.

Particularly high stable enzyme concentrations are possible, as already discussed by eliminating the bleach activator and by the addition of hydroxydi-, or hydroxy tri-carboxylic acid, preferably in the form of an alkali-metal salt and of a carbonate salt.

A preferred feature of the invention is an enzyme containing tablet or discrete region of a tablet which tablet or region is an admixture comprising:

an enzyme, preferably at 5 to 50% wt, ideally 20 to 45% wt, or 30 to 40% wt;

an aliphatic hydroxydi- or hydroxy tri-carboxylic acid, or an alkali metal salt thereof, preferably at 15 to 50% wt, ideally 17 to 25% wt or 19 to 22% wt;

a carbonate salt selected from the group consisting of alkali metal carbonates, bicarbonates and sesquincarbonates, preferably at 10 to 25% wt, ideally 12 to 20% wt or 15 to 18% wt.

Additional optional ingredients include disintegrants, such as PVP.

Surprisingly we have found that when talcum (magnesium silicate) is added to the admixture in either or both layers the following surprising benefits are achieved when the admixture is compacted:

1) reduced capping occurs in the mould;

2) a significant reduction in disintegration time of the compacted composition is achieved when placed in water;

3) there is a reduction in hardness of the compacted composition after compression but no increase in friability.

Therefore, as a further feature of the invention we present the use of talcum as disintegrant in compacted cleaning compositions.

Preferably the talcum is present in an amount of 0.2% to 10% wt, preferably 0.2% to 5% wt, ideally 0.2% to 2% wt.

A preferred feature of the invention is a three phase system which comprises two phases as described above and in addition a third phase comprising:

An enzyme, preferably at 15 to 50% wt, ideally 20 to 45% wt, or 30 to 40% wt.

An aliphatic hydroxydi- or hydroxy tri-carboxylic acid, or an alkali metal salt thereof, preferably at 15 to 30% wt, ideally 17 to 25% wt or 19 to 22% wt;

A carbonate salt selected from the group consisting of alkali metal carbonates, bicarbonates and sesquincarbonates, preferably at 10 to 25% wt, ideally 12 to 20% wt or 15 to 18% wt.

Ideally the third phase comprises up to 5% wt a disintegrating agent in admixture, such as talcum powder and/or PVP.

Ideally the third phase is a shaped body inserted into the top layer of the tablet, preferably a sphere.

### EXAMPLE 1

A two-phase tablet was prepared having the following ingredients, in which the “white phase” contains the peroxygen bleach and the “blue phase” contains the enzyme.

WHITE PHASE

| Ingredient | % |
|---|---|
| Sodium Percarbonate coated | 75.930 |
| Layer silicate | 4.000 |
| Citric Acid | 5.130 |
| Microcrystalline Cellulose | 7.000 |
| PEG 6000 | 4.000 |
| Sodium Bicarbonate | 2.370 |
| PVP | 1.500 |
| Perfume | 0.070 |
| Total | 100.00 |

BLUE PHASE

| Ingredient | % |
|---|---|
| Layer Silicate G | 4.000 |
| Citrate | 30.375 |
| Microcrystalline Cellulose | 7.000 |
| PEG 6000 | 4.000 |
| Sodium Bicarbonate G | 30.500 |
| PEG 200 | 0.575 |
| Dye | 0.050 |
| PVP | 1.500 |
| Purafect OX Blend 45 | 22.000 |
| Total | 100.00 |
| WHITE PHASE | 74.00 |
| BLUE PHASE | 26.00 |
| Total | 100.00 |

The “white phase” has a pH (measured at 1% concentration in water after 10 minutes of agitation) of 10.2, and a bulk density of 930 grams per milliliter. The “blue phase” has a pH (measured in the same way) of 5.1 and a bulk density of 950 grams per milliliter. The disintegration rates (measured at 20° C.) of the white and blue phases were, respectively, 30 and 40 seconds.

### EXAMPLE 2

A two-phase tablet similar to that of Example 1 was prepared in which the two phases had the following content:

WHITE PHASE

| Ingredient | % |
|---|---|
| Sodium Percarbonate coated | 75.930 |
| Layer Silicate | 4.000 |
| Citric Acid | 5.130 |
| Avicel (cellulose) | 7.000 |
| PEG 6000 | 4.000 |
| Sodium Bicarbonate | 2.370 |
| PVP | 1.500 |
| Perfume | 0.070 |
| Total | 100.00 |

BLUE PHASE

| Ingredient | % |
|---|---|
| Layer Silicate | 4.000 |
| Citrate | 36.375 |
| Avicel (cellulose) | 7.000 |
| PEG 6000 | 4.000 |
| PEG 200 | 0.575 |
| Sodium Bicarbonate | 36.500 |
| PVP | 1.500 |
| Dye | 0.050 |
| Purafect OX Blend 45 | 10.000 |
| Total | 100.00 |

### EXAMPLE 3

A three phase tablet was produced in which the “white phase” contains the peroxygen bleach, the “green phase” contains enzyme and the “blue phase” contains an additional high concentrated enzyme boost.

WHITE PHASE

| Ingredient | % |
|---|---|
| Sodium Percarbonate coated | 75.930 |
| Layer Silicate | 4.000 |
| Citric Acid | 5.130 |
| Avicel (cellulose) | 7.000 |
| PEG 6000 | 4.000 |
| Sodium Bicarbonate | 2.370 |
| PVP | 1.500 |
| Perfume | 0.070 |
| Total | 100.00 |

GREEN PHASE

| Ingredient | % |
|---|---|
| Layer Silicate G | 4.00 |
| Citric Acid | 17.50 |
| Microcrystalline Cellulose | 7.00 |
| PEG 6000 | 4.00 |
| Sodium Bicarbonate | 10.94 |
| PVP | 1.50 |
| TAED G | 50.0 |
| Enzyme 45 | 5.06 |
| Total | 100.00 |

BLUE PHASE

| Ingredient | % |
|---|---|
| Microcrystalline Cellulose | 20.00 |
| PEG 6000 | 3.0 |
| Sodium Bicarbonate | 16.50 |
| Enzyme 45 | 37.00 |
| Citrate | 21.30 |
| Talcum | 2.00 |
| Dye | 0.20 |
| Total | 100.00 |

The maximum disintegration times (at 20-25° C.) for the white/green layer was 55 seconds and for the pill 20 seconds.

### EXAMPLE 4

WHITE PHASE

| Ingredient | % |
|---|---|
| Sodium Percarbonate coated | 75.930 |
| SKS Layer Silicate G | 4.000 |
| Microcrystalline Cellulose (200) | 7.000 |
| Citric Acid | 5.130 |
| PEG 6000 | 4.000 |
| Sodium Bicarbonate | 2.370 |
| PVP | 1.500 |
| Perfume | 0.070 |
| Total | 100.00 |

GREEN PHASE

| Ingredient | % |
|---|---|
| Layer Silicate | 4.00 |
| Citric Acid | 17.50 |
| Microcrystalline Cellulose | 7.00 |
| PEG 6000 | 4.00 |
| Sodium Bicarbonate | 10.94 |
| PVP | 1.50 |
| TAED G | 46.00 |
| Enzyme 45 | 5.06 |
| Water and minor components | 4.00 |
| Total | 100.00 |

BLUE PHASE

| Ingredient | % |
|---|---|
| Microcrystalline Cellulose | 20.00 |
| PEG 6000 | 3.00 |
| Sodium Bicarbonate | 24.80 |
| Enzyme 45 | 10.00 |
| Citrate | 40.00 |
| Talcum | 2.00 |
| Dye | 0.20 |
| Total | 100.00 |

### EXAMPLE 5

WHITE PHASE

| Ingredient | % |
|---|---|
| Sodium Percarbonate coated | 75.932 |
| SKS Layer Silicate | 4.000 |
| Microcrystalline Cellulose | 7.000 |
| Citric Acid | 5.130 |
| PEG 6000 | 4.000 |
| Sodium Bicarbonate | 2.370 |
| PVP | 1.500 |
| Perfume | 0.068 |
| Total | 100.00 |

GREEN PHASE

| Ingredient | % |
|---|---|
| Layer Silicate G | 4.00 |
| TAED G | 50.000 |
| Citric Acid | 15.70 |
| Microcrystalline Cellulose | 7.00 |
| PEG 6000 | 4.00 |
| Sodium Bicarbonate | 10.94 |
| PVP | 1.50 |
| Enzyme 45 | 6.86 |
| Total | 100.00 |

### Test Results

A) The effectiveness of tablets prepared according to Example 2 was tested, in a series of four replications. A tablet weighing 0.41 grams and 1.82 grams of a commercially available liquid detergent were placed in a washing machine in one liter of water, together with fabrics having aged stains of chocolate ice cream, grass, EMPA 161 (a standard soil comprising blood, milk and carbon block) and mixed fruit. The washing temperature was 30° C., and the fabrics were washed for 12 minutes at 50 rpm with two rinses of 5 minutes each. The water hardness was 25° F. After treatment with the detergent and the enzyme-containing bleach tablet of this invention, no visible stains were observed.

B) The effect of adding talcum powder to the admixture was tested by adding a variety of amounts of talcum powder to the white phase of example 3.

| | Disintegration | | % Fria- | |
|---|---|---|---|---|
| % Talcum | (in minutes) | Capping | bility | Hardness |
| 0 | 29 | Level 2 | 0.33 | 148 N |
| 1 | 14 | Level 1 | 0 | 116 N |
| 1.5 | 8 | O.K. | 0.88 | 74 N |

c) The effect of the enzyme on the stability, line speed and disintegration time of the tablets was assessed

| | | |
|---|---|---|
| Enzyme % | 5% | 22% |

| | | | | |
|---|---|---|---|---|
| Hardness | 200 | N | 232 | N |
| Disintegration | 49 | sec | 23 | sec |
| Friability | 7.2% | | 5.6% | |
| Line Speed | 550 | tabs/min | 600 | tabs/min |

| | Loss % |
|---|---|
| Enzyme % | after 90 days |
| 5 | 100 |
| 6.86-Example 5 | 64 |
| 10-Example 4 | 52.6 |
| 22-Example 1 | 47.4 |
| 37-Example 3 | 40.6 |

1. A compacted fabric cleaning tablet comprising in admixture at least 5.5% wt of an enzyme.

2. A compacted fabric cleaning tablet as claimed in claim 1 in which the enzyme added to the admixture is less than 10% wt pure.

3. A compacted fabric cleaning tablet as claimed in claim 1 or claim 2 which additionally comprises in the admixture an aliphatic hydroxydi- or hydroxytri-carboxylic acid or an alkali salt thereof.

4. A compacted fabric cleaning tablet as claimed in any claim from 1 to 3 which additionally comprises in the admixture a carbonate salt selected from the group consisting of alkali metal carbonates, bicarbonates and sesquicarbonates.

5. A compacted fabric cleaning tablet as claimed in any claim from 1 to 4 which additionally comprises in the admixture a finely divided water-soluble cellulose.

6. A compacted fabric cleaning tablet as claimed in any claim from 1 to 5 which additionally comprises in the admixture a disintegrant.

7. A tablet comprising at least two phases in which a first phase is an admixture comprising
a peroxygen bleach compound,
an aliphatic hydroxydi- or hydroxytri-carboxylic acid or an alkali metal salt thereof,
a finely divided water-soluble cellulose,
polyethylene glycol having a molecular weight of from about 600 to about 10,000,
a carbonate salt selected from the group consisting of alkali metal carbonates, bicarbonates and sesquicarbonates, and
a disintegrant,
and a second phase is an admixture comprising
at least 5.5% wt preferably greater than 10% wt, greater than 15% wt, greater than 20% wt, greater than 25% wt, greater than 30% wt, or greater than 35% wt, of an enzyme,
an aliphatic hydroxydi- or hydroxytri-carboxylic acid or an alkali salt thereof,
a finely divided water-soluble cellulose,
polyethylene glycol having a molecular weight of from about 600 to about 10,000,
a carbonate salt selected from the group consisting of alkali metal carbonates, bicarbonates and sesquicarbonates, and a disintegrant.

8. An enzyme containing two-phase bleaching tablet in which a first phase is an admixture comprising
a peroxygen bleach compound,
an aliphatic hydroxydi- or hydroxytri-carboxylic acid or an alkali salt thereof,
a fine divided water-soluble cellulose,
polyethylene glycol having a molecular weight of from about 600 to 10,000,
a carbonate salt selected from the group consisting of alkali metal carbonates, bicarbonates and sesquicarbonates, and
polyvinylpolypyrrolidone
and a second phase is an admixture comprising
an enzyme component,
an aliphatic hydroxydi- or hydroxytri-carboxylic acid or an alkali salt thereof,
a finely divided water-soluble cellulose,
polyethylene glycol having a molecular weight from about 600 to about 10,000,
a carbonate salt selected from the group consisting of alkali metal carbonates, bicarbonates and sesquicarbonates, and
polyvinylpolypyrrolidone
wherein the tablet comprises from about 60 weight percent to about 85 weight percent of the first phase admixture and from about 40 weight percent to about 15 weight percent of the second phase admixture.

9. A tablet according to claim 8 in which the first phase and second phase each additionally comprise crystalline layered sodium silicate.

10. A tablet according to claims 7 or 8 in which the peroxygen bleach compound is an alkali metal perborate, percarbonate or persulfate, and the carbonate salt is an alkali metal bicarbonate.

11. A tablet according to claim 10 in which
the peroxygen bleach compound is sodium percarbonate,
the salt of the hydroxycarboxylic acid is sodium citrate,
the cellulose in both phases is microcrystalline cellulose,
the polyethylene glycol in both phases has a molecular weight of from about 5,000 and about 7,000, and
the carbonate salt in both phases is sodium bicarbonate,
and the tablet comprises from 70 to 80 weight percent of the first phase admixture and from 30 to 20 weight percent of the second phase admixture.

12. A tablet according to claim 11 in which the first phase admixture comprises
from 70% to 80% of sodium percarbonate,
from 3% to 5% of layered sodium silicate,
from 4% to 6.5% of sodium citrate,
from 6% to 8% of microcrystalline cellulose,
from 3% to 5% of polyethylene glycol,
from 1.5% to 3.5% of sodium bicarbonate, and
from 1% to 2% of polyvinylpolypyrrolidone,
and the second phase admixture comprises
from 15% to 30% of the enzyme component,
from 3% to 5% of layered sodium silicate,
from 25% to 35% of sodium citrate,
from 6% to 8% of microcrystalline celluloses,
from 3% to 5% of polyethylene glycol,
from 25% to 35% of sodium bicarbonate, and
from 1% to 2% of polyvinylpolypyrrolidone.

13. A bleaching tablet according to any of the preceding claims in which the enzyme component is a mixture of protease and amylase enzymes.

14. A bleaching tablet according to any of the preceding claims in which the two phases are segregated in discrete regions of the tablet.

15. A tablet according to claim 14 in which the tablet is a two-layered structure in which one layer is of a different colour or shade from the other.

16. A tablet comprising or a discrete region of a tablet which tablet or region is an admixture comprising;
an enzyme, preferably at 5 to 50% wt, ideally 20 to 45% wt, or 30 to 40% wt;
an aliphatic hydroxydi- or hydroxy tri-carboxylic acid, or an alkali metal salt thereof, preferably at 15 to 50% wt, ideally 17 to 25% wt or 19 to 22% wt;
a carbonate salt selected from the group consisting of alkali metal carbonates, bicarbonates and sesquincarbonates, preferably at 10 to 25% wt, ideally 12 to 20% wt or 15 to 18% wt.

17. A three phase tablet comprising an initial two phases, ad claimed in any claim from 1 to 9, and third phase as claimed in claim 10.

18. A tablet as discussed in any preceding claim which comprises within the admixture in at least one phase talcum.

19. The use of a talcum as a disintegrant in compacted laundry cleaning compositions.
